(19) United States
(12) Patent Application Publication
(10) Pub. No.: US 2008/0130191 A1
(43) Pub. Date: Jun. 5, 2008

(54) Method and apparatus for monitoring and controlling ionizing blowers

(75) Inventor: Peter Gefter, South San Francisco, CA (US)

Correspondence Address: MKS/Ion Systems;Attn: John E. Menear, Suite 100, 1750 North Loop Road, Alameda, CA, 94502, US

(73) Assignee: MKS/Ion Systems

(21) Appl. No.: 11/998,767

(22) Filed: Nov. 30, 2007

Related U.S. Application Data
(60) Provisional application No. 60/872,677, filed on Dec. 4, 2006.

(51) Int. Cl. H01T 23/00

(52) U.S. Cl. 361/231

(57) ABSTRACT

An apparatus and method for monitoring the output of an ionizing blower. A measuring chamber captures a portion of the air ion stream, and measures balance plus air ion current. Since the measurement chamber is isolated from extraneous electrostatic fields, measurements contain less analytical noise. Air flow through the measurement chamber is created by the inherent pressure difference between the high pressure and low pressure sides of an air mover. Two electrodes inside the measurement chamber are combined with a power supply, a low current amplifier, and a controller. The controller also makes adjustments to the ionizing blower.

### CROSS-REFERENCE TO RELATED APPLICATIONS

This application claims priority to U.S. Provisional Application No. 60/872,677 entitled “METHOD AND APPARATUS FOR MONITORING AND CONTROLLING IONIZING BLOWERS” filed on Dec. 4, 2006.

### STATEMENT REGARDING FEDERALLY SPONSORED RESEARCH

Not Applicable

### REFERENCE TO A MICROFICHE APPENDIX

Not Applicable

### BACKGROUND OF THE INVENTION

1. Field of the Invention

This invention relates to static charge neutralizers, which are designed to remove or minimize static charge accumulation. Static charge neutralizers remove static charge by generating air ions and delivering those ions to a charged target.

One specific category of static charge neutralizer is the ionizing blower. An ionizing blower normally generates air ions with a corona electrode, and uses a fan (or fans) to direct air ions toward the target of interest.

Monitoring or controlling the performance of a blower utilizes two measurements.

The first measurement is balance. Ideal balance occurs when the number of positive air ions equals the number of negative air ions. On a charge plate monitor, the ideal reading is zero. In practice, the static neutralizer is controlled within a small range around zero. For example, a static neutralizer's balance might be specified as 0±2 volts.

The second measurement is air ion current. Higher air ion currents are useful because static charges can be discharged in a shorter time period. Higher air ion currents correlate with low discharge times that are measured with a charge plate monitor.

In practice, charge plate monitors are not used for continuous monitoring or feedback control. The expense would be prohibitive.

This instant invention describes a practical method and apparatus for monitoring and controlling ionizing blowers.

2. Description of Related Art

There are many sensors suggested to monitor and control ionizing blowers. The two most common sensors are: (1) a conductive grid connected to a low current amplifier, and (2) a three electrode combination.

The conductive grid sensor measures air ion current, and uses this information to assess ion balance. The conductive grid works, but it possesses disadvantages.

One disadvantage of the conductive grid sensor is that the conductive grid consumes a large fraction (as much as 30%) of the blower's air ion output. Hence, the blower operates at a low efficiency.

A second disadvantage of the conductive grid sensor is its response to environmental interference. The grid sensor is exposed to external electric fields, which induce unwanted currents that contribute noise to the measurement. Fans, heaters, lights, and motors are examples of devices which generate electric fields. In the presence of environmental interference, both accuracy and sensitivity are compromised.

Any attempt to shield the grid sensor from external electric fields creates an obstacle to air flow. It also makes the blower larger. Moving the grid away from electric field generators limits installation options.

A third disadvantage of the conductive grid sensor is that it can only measure net current. And net current contains no information concerning total ion output. For example, 110 nanoamps of positive air ion flow and 100 nanoamps of negative air ion flow would read 10 nanoamps of positive air ion flow. And 15 nanoamps of positive air ion flow and 5 nanoamps of negative air ion flow would also read 10 nanoamps of positive air ion flow.

A three electrode sensor can measure balance and air ion current. This sensor comprises of two reference electrodes and one voltage or current sensitive electrode. However, it has the same disadvantages as the grid sensor, such as high sensitivity to electrical noise.

A new type of sensor is needed for monitoring and controlling ionizing blowers. The new sensor should measure balance and air ion current. And it should be insensitive to environmental interference.

### BRIEF SUMMARY OF THE INVENTION

This present invention takes a sample of ionized air from the blower's output, and measures that sample inside a measurement chamber which is isolated from external electric fields. Isolation of the measurement chamber is achieved with an outside electrostatic grounded screen, film, or coating positioned over an inner dielectric flow path.

The measurement chamber is constructed as a bypass air channel, and is positioned between the blower's inlet side and the blower's outlet side. Air flow through the measurement chamber is driven by the differential pressure created by the fan (or other air mover). The blower outlet side is a high pressure zone, and the blower inlet side is a low pressure zone.

Most blower fans produce enough pressure differential (outlet side minus inlet side) to create a useful air velocity through the measurement chamber. For example, a pressure differential of 0.005 inches of water creates a velocity of roughly 280 feet/minute through an unrestricted measurement chamber.

Inside the measurement chamber are a first electrode and a second electrode. The first electrode (sometimes ring shaped) is attached to a power supply. A typical power supply can supply between +1000 and −1000 volts to the first electrode, but this is not intended as a power supply specification. Normally, ±100 volts is sufficient. The second electrode may be constructed as a small metal filter, which acts as an ion trap. This second electrode is connected to the input of a low current amplifier.

Both the power supply (attached to the first electrode) and the low current amplifier (connected to the second electrode) are connected to a controller.

When measuring ion balance, the controller holds the first electrode at ground potential. In this condition, virtually all air ions will be collected by the second electrode. A positive current through the low current amplifier indicates a positively shifted balance. A negative current indicates a negatively shifted balance. Zero current from the second electrode indicates ideal balance.

To measure air ion current, the controller applies a voltage (positive or negative) to the first electrode. If the applied voltage is positive, negative air ions are removed from the air stream by the first electrode. Hence, only positive air ions are measured at the second electrode. The amplitude of the positive current from the low current amplifier is fed to the controller.

If the applied voltage is negative, positive air ions are removed from the air stream by the first electrode. Hence, only negative air ions are measured at the second electrode.

With accurate information on balance, positive ion current, and negative ion current, the controller can make precise corrective adjustments to the ionizing blower.

The present invention is useful for most types of ionizing blowers.

Objects of this inventions include:

(1) measure and adjust blower balance; (2) measure and adjust the blower's positive air ion density; (3) measure and adjust the blower's negative air ion density; and (4) exclude environmental noise from the measurements.

### BRIEF SUMMARY OF THE FIGURES

FIG. 1 is a diagram of an ionizing blower that has been modified with the invented feedback.

### DETAILED DESCRIPTION

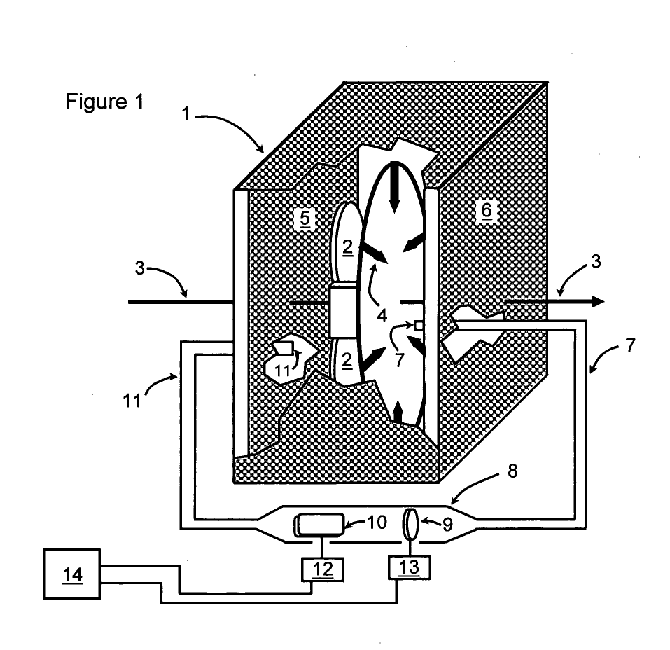

FIG. 1 shows an example of the inventive concept applied to an ionizing blower 1. The ionizing blower 1 has an inlet side 5 and an outlet side 6. Air flows through the blowing ionizer 1 along air flow direction 3.

A fan 2 (or other air mover) sucks air into the blowing ionizer 1 through the inlet side 5. The inlet side 5 comprises the low pressure side (relative to the surrounding room) because the fan pulls air from this region.

The high pressure side of the blowing ionizer 1 is the outlet side 6 because the fan 2 blows air toward this region. As shown in FIG. 1, the emitters 4 are downwind from the fan 2. However, the current invention also works when the emitters 4 are upwind from the fan 2. Air ions are produced by the emitters 4, and the air ions exit via the outlet side 6.

A measurement chamber 8 receives ionized air through the sampling device 7 from the outlet side 6 of the ionizing blower 1. Air from the measurement chamber 8 is returned to the inlet side 5 of the ionizing blower 1 through exit device 11. The differential pressure across the measurement chamber 8 creates the air flow through the measurement chamber 8. No separate air mover is needed.

A controller 14 directs the measurement of balance and air ion current. Balance and air ion currents are measured in separate time periods, and each time period requires different voltages on the power supply 13.

To measure balance, the first electrode 9 is held at zero voltage relative to ground. In this condition, the first electrode 9 does not purposely remove ions from the air stream. Practically, all air ions are trapped at the second electrode 10 which is attached to a low current amplifier 12. If the ionizing blower 1 has a positive balance, the low current amplifier 12 reports a positive current. If the ionizing blower 1 has a negative balance, the low current amplifier 12 reports a negative current. Zero current through the low current amplifier 12 indicates zero (ideal) balance.

To measure ion current, a voltage (perhaps 100 volts or less) is applied to the first electrode 9 through a power supply 13. When a positive voltage is applied by the power supply 13, negative air ions are neutralized at the first electrode 9. Hence, only the positive ions are trapped by the second electrode 10 and measured by the low current amplifier 12. When a negative voltage is applied by the power supply 13, positive ions are neutralized at the first electrode 9, and only the negative ions are trapped by the second electrode 10 and measured by the low current amplifier 12.

We claim:

1. An ionizing blower with air ion monitoring comprising:
an ionizer chassis;
an air mover disposed within said chassis which creates air flow through said ionizing blower;
ion emitters positioned in the path of said air flow;
a measurement chamber;
an air sampling device that
receives air ions from the high pressure side of said air mover, and
connects to the entrance segment of said measurement chamber; and
an air exit device that
returns measured air to the low pressure side of said air mover, and
connects to the exit segment of said measurement chamber.

2. Claim 1 where said measurement chamber is constructed from insulative material with a conductive outside covering.

3. Claim 2 where said outside covering is any one of a metal screen, a metal coating, and a wire mesh.

4. Claim 1 where said measurement chamber contains a first electrode and a second electrode, and the first electrode is connected to the output of a power supply.

5. Claim 4 where said power supply is adjustable with a controller.

6. Claim 5 where said controller can adjust said power supply to any voltage between −1000 and +1000 volts.

7. Claim 5 where said controller adjusts said power supply to ground potential during balance measurement by said second electrode.

8. Claim 5 where said power supply is adjusted to a positive voltage during measurement of positive air ion current by said second electrode.

9. Claim 5 where said power supply is adjusted to a negative voltage during measurement of negative air ion current by said second electrode.

10. Claim 1 where said measurement chamber contains a first electrode and a second electrode, and the second electrode is connected to a low current amplifier.

11. Claim 10 where a controller receives one of balance data, negative air ion current data, or positive air ion current data from said low current amplifier.

12. Claim 11 where said balance data is received during a time period in which said first electrode is held at ground potential.

13. Claim 11 where said positive air ion current data is received during a time period in which said first electrode is held at a positive potential.

14. Claim 11 where said negative air ion current data is received during a time period in which said first electrode is held at a negative potential.

15. Claim 11 where said controller adjusts operating parameters of said ionizing blower.

16. Claim 15 where said operating parameters include ion emitter voltage, emitter current,
emitter on-time, or emitter off-time.

17. Claim 1 where flow through said measurement chamber is created by the pressure difference between said high pressure side of said air mover and said low pressure side of said air mover.

18. Claim 1 where said air mover comprises a fan.

19. Claim 1 where said ion emitters comprise corona electrodes.

20. A method of measuring balance and air ion current for an ionizing blower comprising:
placing a first electrode and a second electrode into a measurement chamber;
attaching said first electrode to the output of a power supply;
connecting said second electrode to the input of a low current amplifier;
moving ionized air through said measurement chamber; and
adding a controller which
receives input from said low current amplifier,
determines the voltage of said power supply, and
adjusts operating parameters of said ionizing blower.

21. Claim 20 where said moving is caused by an air pressure difference across an air mover.

22. Claim 21 where said air mover is a fan.

23. Claim 20 where said second electrode measures air ion balance when said controller sets said first electrode to ground potential.

24. Claim 20 where said second electrode measures positive air ion current when said controller sets said first electrode to a positive voltage.

25. Claim 20 where said second electrode measures negative air ion current when said controller sets said first electrode to a negative voltage.

26. Claim 20 where said controller is connected to both said power supply and said low current amplifier.

27. Claim 20 where said operating parameters include emitter voltage, emitter current, emitter on-time, or emitter off-time.

28. Claim 20 where said first and second electrodes have different configurations.

29. Claim 20 where said first electrode has low resistance to air ion flow and may be configured as a ring.

30. Claim 20 where said second electrode is positioned downstream to said first electrode and configured as an ion trap.
